(19) United States
(12) Patent Application Publication
(10) Pub. No.: US 2005/0258191 A1
(43) Pub. Date: Nov. 24, 2005

(54) Fluid dispensing device

(76) Inventor: Michael Birsha Davies, Ware (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/523,163

(22) PCT Filed: Jul. 30, 2003
(86) PCT No.: PCT/EP03/08499

§ 371 Date: Jan. 27, 2005

(30) Foreign Application Priority Data
Aug. 1, 2002 (GB) 0217798.8

(51) Int. Cl. B67D 5/64

(52) U.S. Cl. 222/162; 222/402.15

(57) ABSTRACT

A fluid dispenser having a housing and a pump action fluid discharge device. The pump action fluid discharge device is arranged to be actuated by one or more levers which are pivotally supported within the housing. When the or each lever is rotated about its lower end the fluid discharge device is urged towards a nozzle causing a single dose of fluid to be dispensed from the nozzle. Various mechanisms are proposed for converting the transverse application of force from each lever into a force along a longitudinal axis of the fluid discharge device.

The present invention relates to a medicament dispenser and in particular to a fluid dispensing device for use as a nasal inhaler.

It is well known to provide a medicament dispenser in which fluid is dispensed via a nozzle or orifice upon the application of a force by a user to an actuation lever or button. Such devices may be arranged to dispense a single dose or may alternatively be arranged with a reservoir containing several doses to be dispensed. An example of such a pump action spray is shown and described in U.S. Pat. No. 4,771,769.

The Applicants have now found that for ease of use and efficiency of dispensing of fluid (e.g. as a spray) it is advantageous if the lever is provided to the housing of a medicament dispenser device such that it is pivotally supported at a lower end of the housing but is capable of transferring force to an actuating means that connects to the neck of a fluid container within the housing. Ease of use benefits can arise because a so-configured dispenser may be arranged to be ergonomically amenable to the user. Efficiency benefits can arise because such an arrangement of the lever can provide good mechanical advantage even for a relatively compact dispenser device housing.

It is an object of this invention to provide a fluid dispensing device that is easier to use and in particular a device which provides a more efficient dispensing of fluid.

According to a first aspect of the invention there is provided fluid dispensing device for spraying a fluid into a body cavity comprising a body structure including a housing, a nozzle extending out from an upper end of the housing for insertion into a body cavity, a fluid discharge device moveably housed within the housing, the fluid discharge device comprising a container for storing the fluid to be dispensed having a neck at one end and a compression pump having a suction inlet located within the container and a discharge outlet extending out from the neck of the container for transferring fluid from the pump to the nozzle and at least one lever to apply a force to an actuating means used to move the container towards the nozzle so as to actuate the pump wherein the or each lever is pivotally supported at a lower end within the housing and the actuating means connects to the neck of the container.

By ‘at a lower end within the housing’ it is generally meant at that end of the housing which is distal from the upper end of the housing i.e. that end from which the nozzle extends. In use, the lower end of the housing is therefore typically closer to the base of the container, that is to say the base part of the container, which is distal from the discharge outlet.

This has the advantage that a long lever can be used thereby maximising the mechanical ratio between the input force and the force applied to actuate the pump. In addition the use of a lever pivotally supported at its lower end is ergonomically more efficient than using a lever pivotally supported at an upper end due to the fact that a user will normally grasp the dispensing device with their thumb positioned close to the nozzle and hence in this case at the end of the lever. With a lever pivotally supported at an upper end the location of a users thumb is close to the position about which the lever pivots and hence the maximum leverage is not obtained.

Suitably, the or each lever is arranged to apply mechanical advantage. That is to say, the or each lever applies mechanical advantage to the user force to adjust (generally, to enhance or smooth) the force experienced by the container. The mechanical advantage may in one aspect, be provided in either a uniform manner such as by a constant mechanical advantage enhancement, for example by a ratio of from 1.5:1 to 10:1 (enhanced force:initial force), more typically from 2:1 to 5:1. In another aspect, the mechanical advantage is applied in a non-constant manner such as progressive increase or progressive decrease of mechanical advantage over the applied force cycle. The exact profile of mechanical advantage variation may be readily determined by reference to the desired spray profile and all relevant characteristics of the device and formulation to be sprayed (e.g. viscosity and density).

Preferably, the actuating means connects to the neck of the container by a collar engaging with the neck of the container.

In one aspect, there are two opposing levers each of which is pivotally supported near a lower end of the housing and is arranged to act upon the actuating means so as to urge the container towards the nozzle when the two levers are squeezed together by a user.

The or each lever may be pivotally connected to part of the housing.

Suitably, a pre-load means is provided to prevent actuation of the compression pump until a pre-determined force is applied to the or each lever. The pre-load means acts such as to prevent actuation of the compression pump until a pre-determined force is applied to the finger operable means. The pre-determined force may thus, be thought of as a ‘threshold’ or ‘barrier’ force which must first be overcome before actuation of the compression pump can occur.

The quantum of pre-determined force that is to be overcome before actuation of the compression pump is enabled is selected according to various factors including characteristics of the pump, typical user profile, nature of the fluid and the desired spray characteristics.

Typically, the pre-determined force is in the range from 5 to 30N, more typically from 10 to 25N. That is to say, typically from 5 to 30N, more typically from 10 to 25N of force must be applied to the finger operable means before actuation of the compression pump is enabled. Such values tend to correspond to a force which prevents a suitable ‘barrier force’ to a weak, nondescript or unintended finger movement whilst readily being overcome by the determined finger (or thumb) action of a user. It will be appreciated that if the device is designed for use by a child or elderly patient it may have a lower pre-determined force than that designed for adult usage.

In one aspect, the pre-load means is physically interposed between the or each lever and the container.

In which case, the pre-load means may comprise of a step formed on the container which must be ridden over by the or each lever before the compression pump can be actuated wherein the step is over-ridden when the pre-determined force is applied to the or each lever.

Alternatively, the pre-load means may comprise of a step formed on the or each finger operable means (e.g. lever) which must be ridden over by the container before the compression pump can be actuated wherein the step is over-ridden when the pre-determined force is applied to the or each lever.

In yet a further alternative, the pre-load means may comprise of at least one detent formed on one of the container or the or each lever and a recess formed on the other of the container or the or each lever wherein the or each detent is able to ride out of the recess with which it is engaged when the pre-determined force is applied to the or each lever.

In another aspect the pre-load means is interposed between the housing and the container.

In which case, the pre-load means may comprise of one or more detents formed on the container for engagement with part of the housing, the or all of the detents being disengageable from the housing when the pre-determined force is applied to the or each lever so as to allow the compression pump to be actuated.

Alternatively, the pre-load means may comprise of one or more detents formed on the housing for engagement with part of the container, the or all of the detents being disengageable from the container when the pre-determined force is applied to the or each lever so as to allow the compression pump to be actuated.

In a further aspect, the pre-load means is interposed between the container and the discharge outlet.

In which case, the pre-load means may comprises of a step formed on the discharge outlet and at least one latching member attached to the container, the arrangement being such that, when the pre-determined force is applied to the or each lever, the or each latching member is able to ride over the step so as to allow the compression pump to be actuated.

Alternatively, the pre-load means may comprise of a recess formed on the discharge outlet and at least one latching member attached to the container, the arrangement being such that, when the pre-determined force is applied to the or each lever, the or each latching member is able to ride out of the recess so as to allow the compression pump to be actuated.

In a further aspect, the pre-load means is interposed between the housing and the or each lever.

In which case, the pre-load means may comprise of at least one detent formed on the housing for engagement with the or each lever, the or all of the detents being disengageable from the respective lever when the pre-determined force is applied to the or each lever so as to allow the compression pump to be actuated.

Alternatively, the pre-load means may comprise of at least one detent formed on the or each lever for engagement with part of the housing, the or all of the detents being disengageable from the housing when the pre-determined force is applied to the or each lever so as to allow the compression pump to be actuated.

In a further aspect, the pre-load means is interposed between the actuating means and the housing.

In which case, the pre-load means may comprise of at least one detent formed on part of the actuating means for engagement with part of the housing, the or all of the detents being disengageable from the housing when the pre-determined force is applied to the or each lever so as to allow the compression pump to be actuated.

Alternatively, the pre-load means may comprise of at least one detent formed on part of the housing each detent being arranged for engagement with a complementary recess formed on part of the actuating means, each detent being disengageable from its respective recess when the pre-determined force is applied to the or each lever so as to allow the compression pump to be actuated.

In a further aspect, the pre-load means is interposed between the or each lever and the respective actuating means.

In which case, the pre-load means may comprise of at least one detent formed on the or each lever for engagement with a respective recess formed on part of the actuating means, each detent being disengageable from its respective complementary recess when the pre-determined force is applied to the or each lever so as to allow the compression pump to be actuated.

Alternatively, the pre-load means comprises of at least one detent formed on each actuating means for engagement with a recess formed on a respective lever, each detent being disengageable from its respective complementary recess when the pre-determined force is applied to the or each lever so as to allow the compression pump to be actuated.

As yet a further alternative, the preload means may comprise of an actuating device having a variable mechanical ratio such that until the pre-determined force is applied to the or each lever no significant force is transferred to the container along the longitudinal axis.

The fluid dispensing device may alternatively comprise a single lever and the pre-load means may further comprise of a spring interposed between the lever and the container, the spring being used to urge the container towards the nozzle so as to actuate the compression pump.

In which case the spring may be compressed by movement of the lever until the pre-determined force is applied (i.e. by a combination of user-applied force and stored spring force), at which point the threshold of the pre-load means used to prevent actuation of the compression pump is overcome by the force being applied to the container such that the container moves rapidly towards the nozzle so as to actuate the compression pump.

Suitably, the fluid dispensing device is additionally provided with force modifying means for modifying the force applied to the container. That is to say, means for modifying the force applied to (and therefore, ultimately acting on) the container compared to that force directly applied to the or each lever by the user.

Suitably, the force modifying means acts such as to amplify the force applied (i.e. it comprises force amplifying means). The amplification may be provided in either a uniform manner such as by a constant amplification, for example by a ratio of from 1.5:1 to 10:1 (amplified force:initial force; i.e. degree of amplification of from 1.5 to 10), more typically from 2:1 to 5:1. In another aspect, the amplification is applied in a non-constant manner such as progressive increase or progressive decrease of mechanical advantage over the applied force cycle.

The exact profile of force modification may be readily determined by reference to the desired spray profile and all relevant characteristics of the device and formulation to be sprayed (e.g. viscosity and density).

The force modifying means may in one aspect, be integral with the or each lever. In this aspect, the force modifying means may comprise an aspect of the or each lever shaped to give rise to a mechanical advantage.

In another aspect, the force modifying means is located non-integral with the or each lever, and typically between the or each lever and the container. Again this aspect, the force modifying means may comprise an aspect of the or each lever shaped to give rise to a mechanical advantage.

In one aspect, the force modifying means only acts (i.e. only acts to modify the user applied force) once the pre-determined force has been overcome. In preferred aspects, the modifying force acts such that once the pre-determined force has been overcome the force applied to the container is either relatively constant or increases on a relatively constant basis.

In one particular aspect, the force modifying means additionally comprises a stop feature, which acts to stop force being applied to the container once either a particular maximum force is reached or more typically, once the container has been moved a particular distance. In one aspect, the stop functions to prevent excess force being applied to the compression pump.

According to a first embodiment of the first aspect of the invention the actuating means comprises of at least one elongate member interposed between a position of connection to the collar and a position of interaction with a respective lever.

The position of interaction is a position where an end portion of each elongate member reacts against a stop associated with the respective lever.

The stop may be a projection on a surface of the respective lever facing the container. The projection may be formed as an integral part of the respective lever.

Alternatively, the stop may be a recess formed in a surface of the respective lever facing the container with which the end portion of the elongate member may be engaged.

Preferably, each elongate member may be formed as an integral part of the collar.

There may be two elongate members interposed between each lever and the collar.

The container may have a longitudinal axis and each elongate member may have a longitudinal axis extending between the position of connection to the collar and the position of interaction with the respective lever, the longitudinal axis of each elongate member may be arranged at an included angle with respect to the longitudinal axis of the container such that the respective elongate member diverges away from the longitudinal axis of the container as it extends from the position of connection to the collar to the position of interaction with the respective lever.

When the or each lever is moved to cause the container to be moved towards the nozzle, the included angle between the longitudinal axis of each elongate member and the longitudinal axis of the container may be reduced.

When each lever is moved to cause the container to be moved towards the nozzle, each elongate member associated therewith may be subjected to elastic bending.

According to a second embodiment of the first aspect of the invention the actuating means is at least one resilient flexible member connected to an upper end of each lever so as to hold the or each resilient flexible member in an upwardly bowed state.

The or each resilient flexible member may be a leaf spring.

The lower end of the or each lever may be pivotally connected to the housing.

When the or each lever is moved towards the container so as to cause the container is to be moved towards the nozzle, the radius of curvature of the or each bowed resilient flexible member may be reduced.

The or each resilient flexible member may be connected to the neck of the container by abutment of an upper surface of the or each resilient flexible member against a collar attached to the neck of the container.

A stop means may be provided to limit rotational movement of each lever away from the container so as to maintain the or each resilient flexible member in a bowed state.

There may be one lever pivotally supported at a lower end within the housing and the or each resilient flexible member is connected at one end to the upper end of the lever and is connected at an opposite end to part of the body structure of the fluid dispensing device. The part of the body structure may be the housing.

The stop may be positioned such that when the lever is displaced fully from the container so as to rest against the stop the linear distance between the upper end of the lever and the position of connection of the or each resilient flexible member to the part of the body structure is less than the un-bowed length of the or each resilient flexible member.

The fluid dispensing device may further include an end cap to protect the nozzle and the upper end of the lever is adapted to automatically open the end cap when the lever is moved to cause the container to be moved towards the nozzle.

The upper end may be adapted by means of a toothed portion formed on the upper end of the lever for engagement with a complementary toothed portion on the end cap.

As a variation to the second embodiment there may be two levers each of which is pivotally supported at a lower end within the housing and the or each resilient flexible member is connected at one end to the upper end of one of the two levers and is connected at an opposite end to the upper end of the other of the two levers.

Preferably, the or each resilient flexible member and the two levers may be formed as a single integral part.

Each stop may be positioned such that when the two levers are displaced fully from the container, so as to rest against their respective stops, the linear distance between the upper ends of the two levers is less than the un-bowed length of the or each resilient flexible member.

According to a third embodiment of the first aspect of the invention the fluid discharge device has a longitudinal axis and the actuating means comprises of at least one abutment surface formed on the collar against which at least one actuating surface formed at an upper end of each lever is arranged to react wherein at least one of the or each actuating surface and the or each abutment surface is arranged at an angle to the longitudinal axis of the fluid discharge device so as to convert a force applied to the levers substantially transversely to the longitudinal axis of the fluid discharge device into a force along the longitudinal axis of the fluid discharge device.

Each abutment surface may be arranged at an angle to the longitudinal axis of the fluid discharge device.

Each actuating surface may be arranged at an angle to the longitudinal axis of the fluid discharge device or alternatively, each actuating surface may be a curved surface.

There may be four abutment surfaces formed on the collar, each being located for co-operation with a respective one of two actuating surfaces formed on the or each lever. Alternatively, there may be two abutment surfaces formed on the collar each being located for co-operation with a respective one of two actuating surfaces formed on the or each lever.

Each lever may be U-shaped in cross-section having first and second flanges joined together by a bridging portion.

The first flange may have an end portion forming a first actuating surface and the second flange may have an end portion forming a second actuating surface.

Each lever may be pivotally supported at a lower end within the housing by a pivotal connection between the lower end of the respective lever and part of the body structure. In which case, the part of the body structure may be the housing.

Each lever may be pivotally supported at a lower end within the housing by a flexible strap joining the lower ends of the two levers.

The housing may have a front wall, a rear wall and two opposing side walls and at least one of the front wall and the rear wall may have an aperture therein to view the level of the fluid in the container.

The body structure may comprise of a plastic housing and a plastic body member.

The nozzle may be formed as an integral part of the plastic body member.

The plastic body member may be fastened to the housing so that the nozzle projects from the upper end of the housing.

The housing may have two apertures formed therein from each of which, in use, a part of a respective one of the levers projects. Alternatively, the body may have two apertures formed therein from each of which, in use, a part of a respective one of the levers projects.

Embodiments are envisaged in which the fluid discharge device is reversibly removable from the housing of the fluid dispensing device. In such embodiments the fluid dispensing device comprises a housing assembly and fluid discharge device receivable thereby.

According to a second aspect of the invention there is provided a fluid discharge device for use in a fluid dispensing device in accordance with the first aspect of the invention.

According to a third aspect of the invention there is provided a housing assembly for a fluid dispensing device comprising a housing for moveably supporting a discharge device, a nozzle extending from an upper end of the housing for insertion into a body cavity and at least one lever to apply, in use, a force to the fluid discharging device so as to actuate the fluid discharge device and supply fluid to the nozzle wherein the or each lever is pivotally supported at a lower end within the housing.

According to a still further aspect of the present invention there is provided a kit of parts comprising a housing assembly as described above and a fluid discharge device receivable thereby. The fluid discharge device has a longitudinal axis and comprises a container for storing the fluid to be dispensed and a compression pump having a suction inlet located within the container and a discharge tube extending along the longitudinal axis for transferring fluid from the pump to the nozzle.

It is also envisaged that the housing assembly could be supplied as a separate item, into which a user or pharmacist later fits a suitable fluid discharge device.

The fluid discharge device is in one aspect in accordance with the first aspect of the invention (i.e. a compression pump-type device). In another aspect, the fluid discharge device is an aerosol container having a dispensing valve (typically, a metering valve, such as a slide valve type metering valve) of the type well-known for use in metered dose inhaler (MDI) type medicament dispensers.

Suitably, the fluid discharge device herein comprises a pre-compression pump, such as a VP3, VP7 or modifications, model manufactured by Valois SA. Typically, such pre-compression pumps are typically used with a bottle (glass or plastic) container capable of holding 8-50 ml of a formulation. Each spray will typically deliver 50-100 μl of such a formulation and the device is therefore capable of providing at least 100 metered doses.

By metered dose inhaler (MDI) it is meant a discharge device suitable for dispensing medicament in aerosol form, wherein the medicament is comprised in an aerosol container suitable for containing a propellant-based aerosol medicament formulation. The aerosol container is typically provided with a metering valve, for example a slide valve, for release of the aerosol form medicament formulation to the patient. The aerosol container is generally designed to deliver a predetermined dose of medicament upon each actuation by means of the valve, which can be opened either by depressing the valve while the container is held stationary or by depressing the container while the valve is held stationary.

Where the medicament container is an aerosol container, the valve typically comprises a valve body having an inlet port through which a medicament aerosol formulation may enter said valve body, an outlet port through which the aerosol may exit the valve body and an open/close mechanism by means of which flow through said outlet port is controllable.

The valve may be a slide valve wherein the open/close mechanism comprises a sealing ring and receivable by the sealing ring a valve stem having a dispensing passage, the valve stem being slidably movable within the ring from a valve-closed to a valve-open position in which the interior of the valve body is in communication with the exterior of the valve body via the dispensing passage.

Typically, the valve is a metering valve. The metering volumes are typically from 10 to 100 μl, such as 25 μl, 50 μl or 63 μl. Suitably, the valve body defines a metering chamber for metering an amount of medicament formulation and an open/close mechanism by means of which the flow through the inlet port to the metering chamber is controllable. Preferably, the valve body has a sampling chamber in communication with the metering chamber via a second inlet port, said inlet port being controllable by means of an open/close mechanism thereby regulating the flow of medicament formulation into the metering chamber.

The valve may also comprise a ‘free flow aerosol valve’ having a chamber and a valve stem extending into the chamber and movable relative to the chamber between dispensing and non-dispensing positions. The valve stem has a configuration and the chamber has an internal configuration such that a metered volume is defined therebetween and such that during movement between is non-dispensing and dispensing positions the valve stem sequentially: (i) allows free flow of aerosol formulation into the chamber, (ii) defines a closed metered volume for pressurized aerosol formulation between the external surface of the valve stem and internal surface of the chamber, and (iii) moves with the closed metered volume within the chamber without decreasing the volume of the closed metered volume until the metered volume communicates with an outlet passage thereby allowing dispensing of the metered volume of pressurized aerosol formulation.

Each lever may be pivotally supported at a lower end within the housing by a pivotal connection between the lower end of the respective lever and the housing.

Alternatively, each lever may be pivotally supported at a lower end within the housing by a flexible strap joining the lower ends of the two levers.

The invention will now be described further with reference to the accompanying drawing in which:

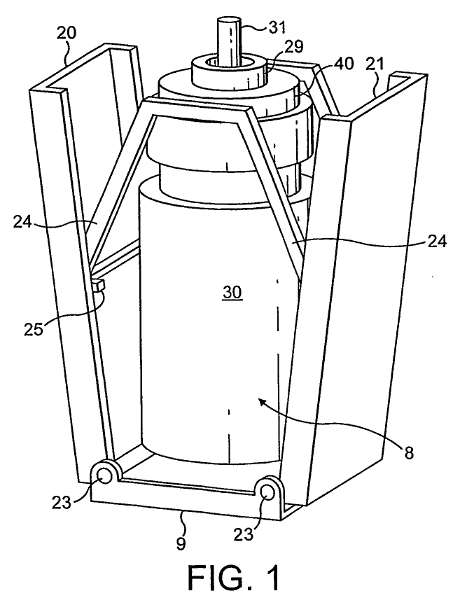

FIG. 1 is a pictorial representation of part of a first embodiment of a fluid dispensing device according to the invention in a ready for use state;

FIG. 2 is a line diagram showing the relationship between various members forming the fluid dispensing device in a ready to use position;

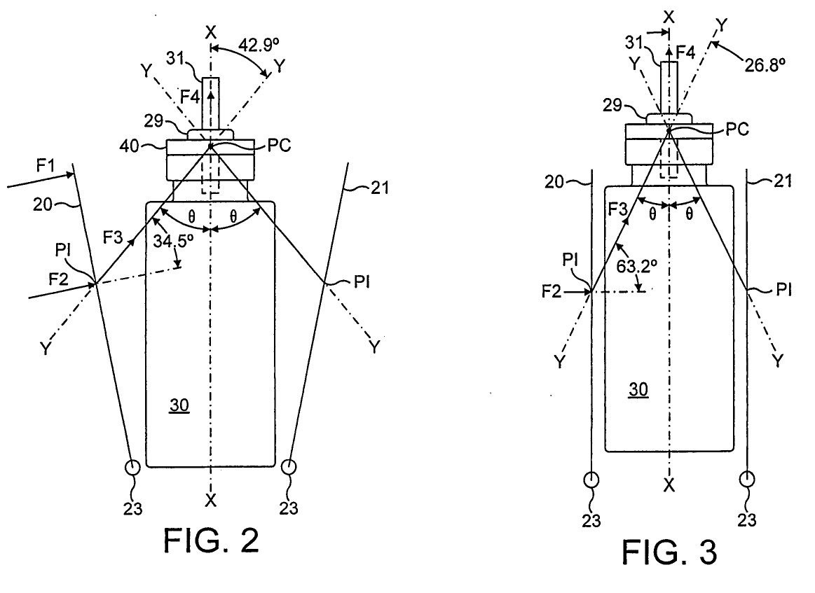

FIG. 3 is a line diagram similar to that shown in FIG. 2 but showing the position of the members in a discharged state at the end of a delivery stroke;

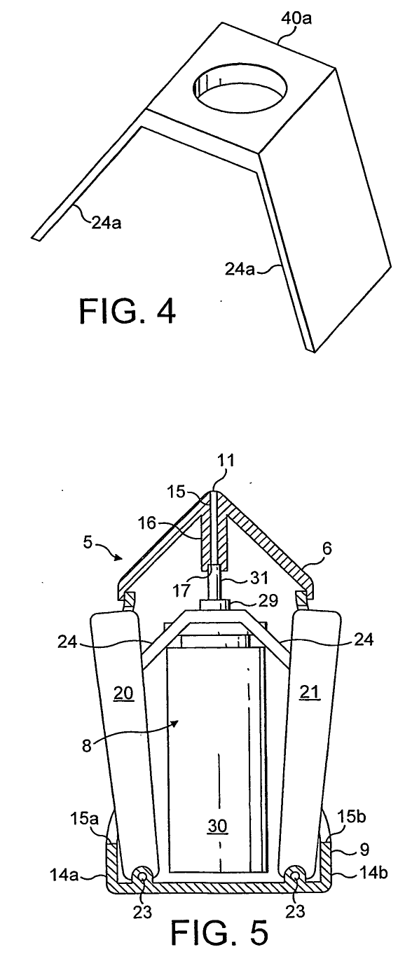

FIG. 4 is a pictorial representation of an alternative collar and actuating means for use in the fluid dispensing device shown in FIG. 1;

FIG. 5 is a cross-section through a fluid dispensing device of which the mechanism shown in FIG. 1 forms a part;

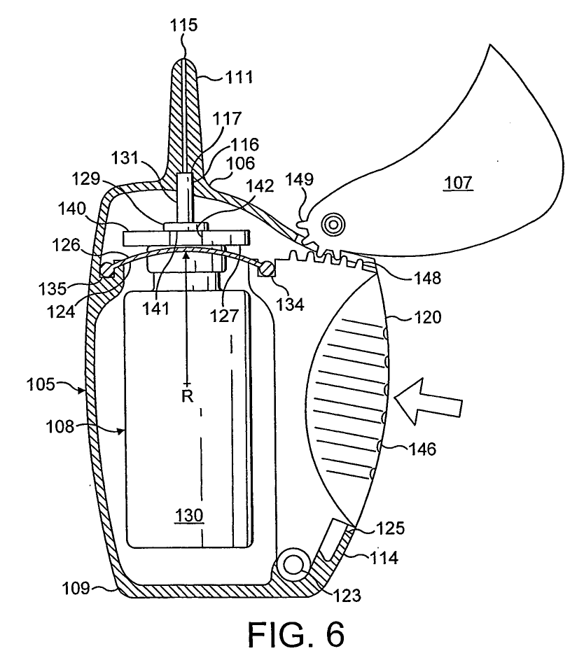

FIG. 6 is a cross-section through a second embodiment of a fluid dispensing device according to the invention with a protective end cap in an open position;

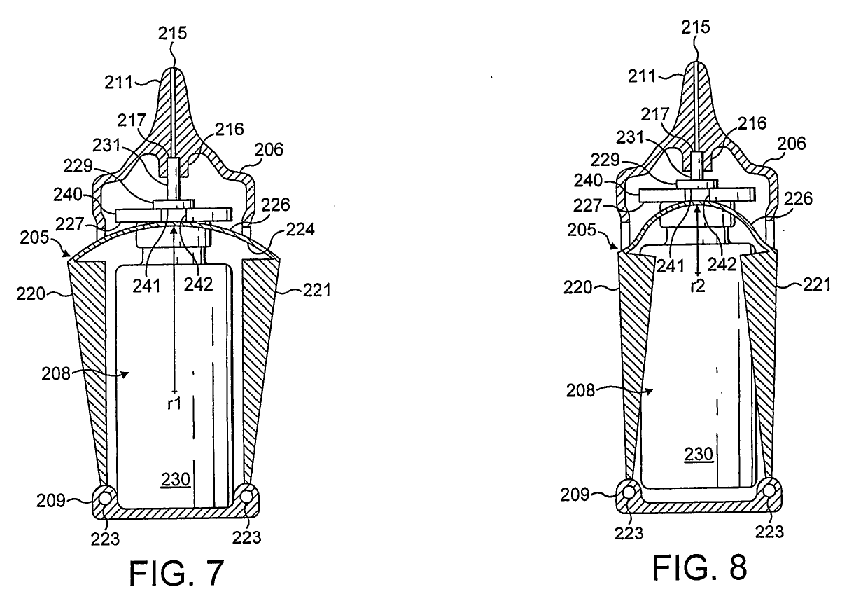

FIG. 7 is a cross-section through an alternative arrangement of the second embodiment in a ready for use position;

FIG. 8 is a cross-section as shown in FIG. 7 but showing the fluid dispensing device in a discharge state at the end of a delivery stroke;

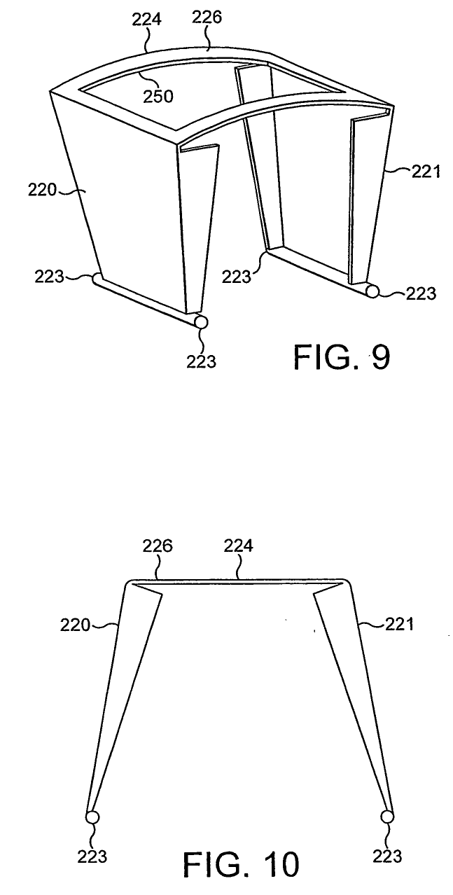

FIG. 9 is a pictorial view of a flexible member and lever arrangement forming part of the fluid dispensing device shown in FIG. 8 in a pre-assembled condition;

FIG. 10 is a side view of the flexible member and lever arrangement shown in FIG. 9;

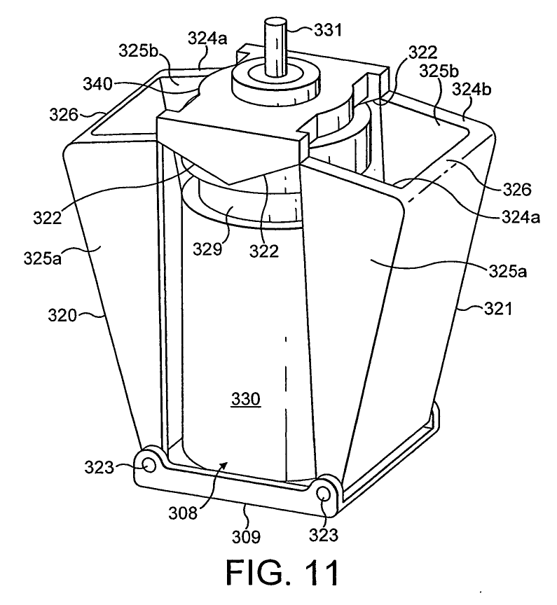

FIG. 11 is a pictorial view of part of a third embodiment of a fluid dispensing device according to the invention in a ready for use state;

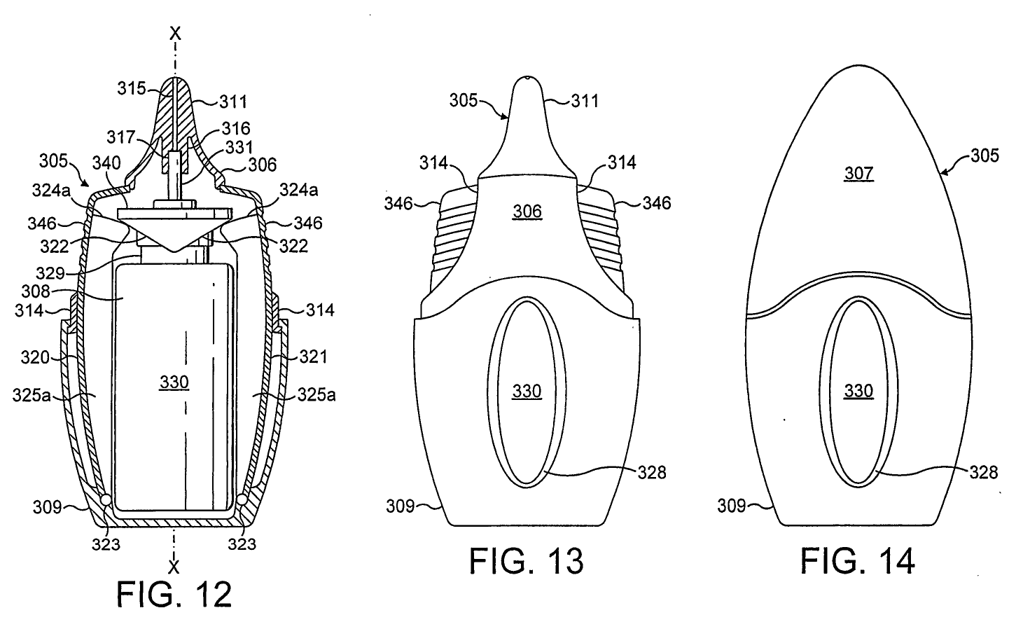

FIG. 12 is a cross-section through a fluid dispensing device according to the invention including the mechanism shown in FIG. 11;

FIG. 13 is a front view of the fluid dispensing device shown in FIG. 12 with an end cap removed;

FIG. 14 is a front view of the fluid dispensing device shown in FIG. 12 with an end cap in place;

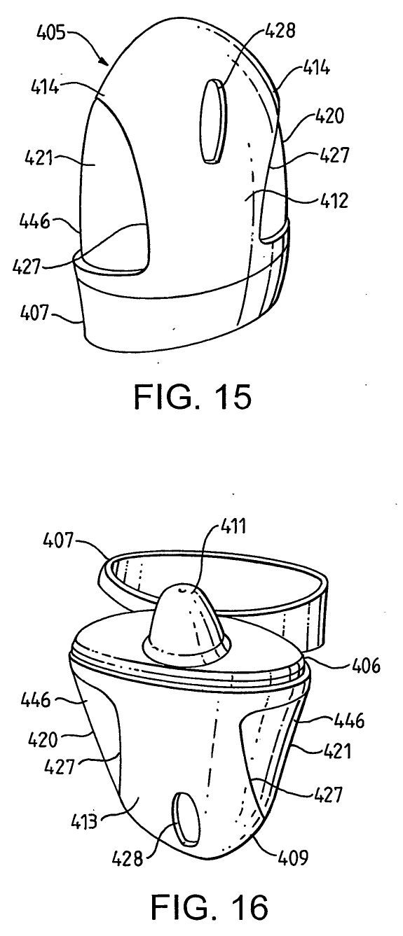

FIG. 15 is a pictorial front view of an alternative arrangement to the embodiment shown in FIGS. 11 to 14 with an end cap in place;

FIG. 16 is a reversed front view of the fluid dispensing device shown in FIG. 15 with the end cap removed;

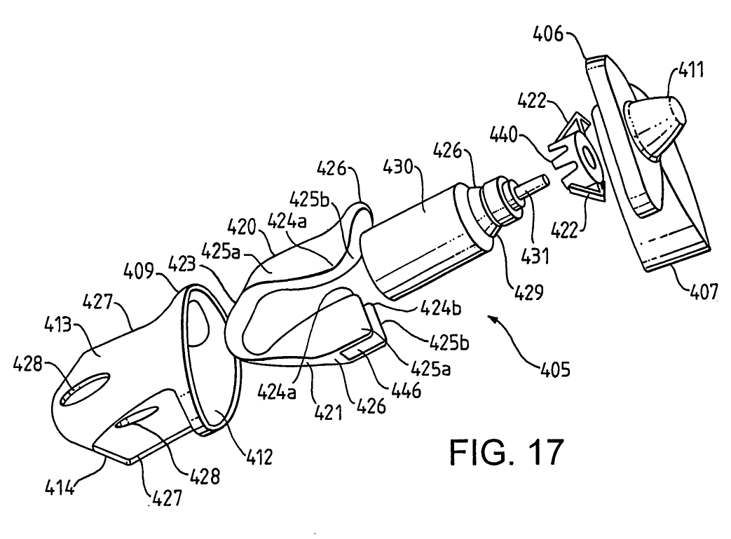

FIG. 17 is an exploded view of the fluid dispensing device shown in FIGS. 15 and 16;

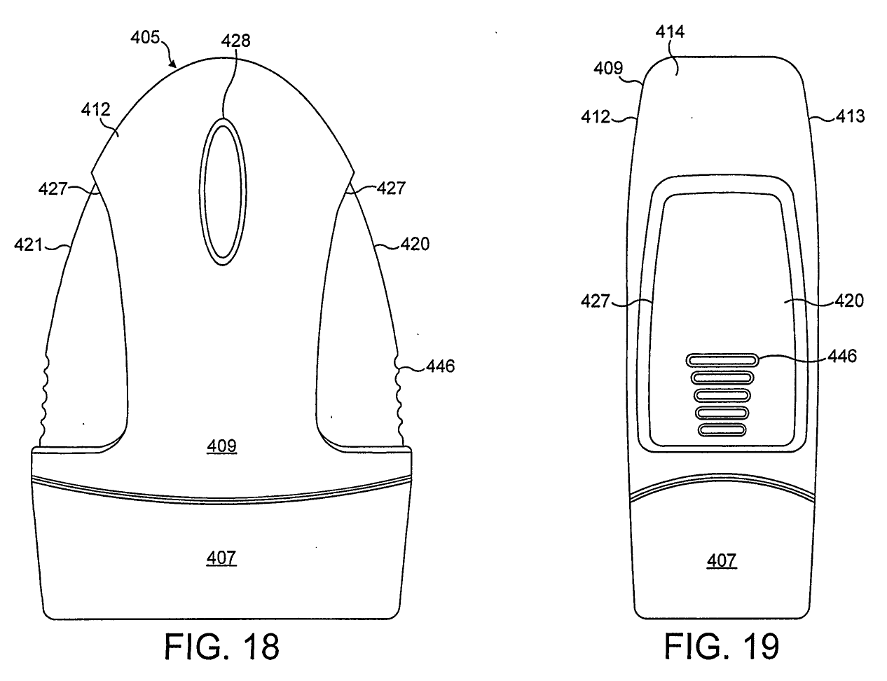

FIG. 18 is an enlarged front view of the fluid dispensing device shown in FIGS. 15 to 17;

FIG. 19 is a side view of the fluid dispensing device shown in FIG. 18; and

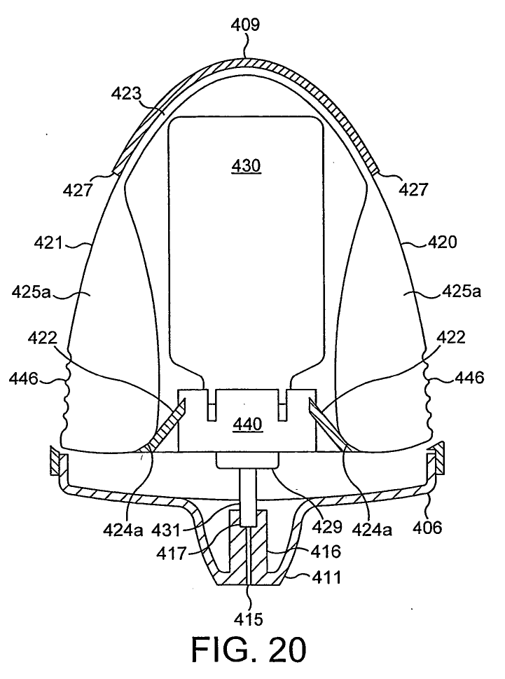

FIG. 20 is a staggered cross-section through the fluid dispensing device shown in FIGS. 18 and 19 with the end cap removed.

With reference to FIGS. 1 to 5 there is shown a first embodiment of a fluid dispensing device 5 for spraying a fluid into a body cavity comprising a body structure including a housing 9, a nozzle 11 extending out from an upper end of the housing for insertion into a body cavity, a fluid discharge device 8 moveably housed within the housing 9, the fluid discharge device 8 comprising a container 30 having a neck 29 at one end for storing the fluid to be dispensed and a compression pump having a suction inlet located within the container 30 and a discharge outlet 31 for transferring fluid from the pump to the nozzle 11 and at least one lever 20, 21 to apply a force to an actuating means 22 used to move the container 30 towards the nozzle 11 so as to actuate the pump. The two opposing levers 20, 21 are pivotally supported at a lower end within the housing 9 and the actuating means 22 is connected to the neck 29 of the container 30 by a collar 40 engaged with the neck 29 of the container 30.

The collar 40 can be attached or engaged with the neck 29 by any suitable means but preferably the collar 40 is designed to snap onto the neck 29 and locate in a groove formed in the neck 29. This arrangement using a snap-on collar allows a standard fluid discharge device to be used without modification.

The fluid dispensing device 5 comprises of a plastic moulded body 6 and the fluid discharge device 8 and further comprises of a protective end cap (not shown) having an inner surface for engagement with the body 6 to protect the dispensing nozzle 11.

The body 6 is made from a plastic material such as polypropylene and the body 6 and the nozzle 11 are made as a single plastic component and are connected to an upper end of the housing 9 so that the nozzle 11 extends away from the housing 9.

The housing 9 defines a cavity formed by a front wall, a rear wall and first and second end walls 14a, 14b. Each of the side walls 14a, 14b has an aperture 18a, 18b formed therein through which the upper end of a restive one of the levers 20, 21 projects.

At least one of the front wall and the rear wall has an aperture (not shown) therein to view the level of the fluid in the container 30.

The discharge outlet from the pump is in the form of a tubular delivery tube 31 and a tubular guide in the form of an outlet tube 16 is formed within the nozzle 11 to align and locate the delivery tube 31 correctly with respect to the nozzle 11.

An annular abutment 17 is formed at the end of the outlet tube 16. The annular abutment 17 defines the entry to an orifice passage 15 through which fluid can flow in use and is arranged for abutment with an end of the delivery tube 31.

The nozzle 11 and the fluid discharge device both have longitudinal axes which are aligned so that when the pump is actuated the force applied to the tubular delivery tube 31 is along the axis of the tubular delivery tube and no bending or deflection of the delivery tube 31 will occur due to the applied force.

The fluid discharge device 8 is in most respects conventional and will only be described briefly herein.

The fluid discharge device 8 comprises of the hollow container 30 defining a reservoir containing several doses of the fluid to be dispensed and the compression pump attached to said one end of the container 30.

The container 30 as shown is made from a translucent or transparent plastics material however it will be appreciate that it could be made from other translucent or transparent materials such as glass.

The pump includes a plunger (not shown) slidingly engaged within a pump casing which defines a chamber (not shown) sized to accommodate a single dose of fluid. The plunger is attached to the tubular delivery tube 31 which is arranged to extend from one end of the pump for co-operation with the outlet tube 16 of the dispensing nozzle 11. The plunger includes a piston (not shown) slidably supported in the chamber formed in the pump casing.

The fluid is discharged through a discharge channel defined by the tubular delivery tube 31 into the orifice passage 15 of the dispensing nozzle 11.

The size of chamber is such that it accommodates a single dose of fluid, the diameter of the chamber and piston combined with the stroke of the plunger being such that a full stroke of the plunger in the chamber will produce a change in volume equal to a single dose of fluid.

The pump casing is connected to the container 30 such that when the piston is moved by a return spring (not shown) into a start position a new dose of fluid is drawn into the cylinder via the suction inlet in the form of a pick-up tube from the container 30 ready for discharge.

The two opposing levers 20, 21 are each pivotally supported near a lower end of the housing 9 by means of pivot pins 23 which pivotally connect each lever 20, 21 to part of the housing 9. The two levers 20, 21 are arranged to act upon the actuating means 22 so as to urge the container 30 towards the nozzle 11 when the two levers 20, 21 are squeezed together by a user.

The actuating means 22 comprises of at least one elongate member 24 interposed between a position of connection ‘PC’ to the collar 40 and a position of interaction ‘PI’ with a respective lever 20, 21.

The position of interaction ‘PI’ is a position where an end portion of each elongate member 24 reacts against a stop 25 associated with the respective lever 20, 21.

The stop is in the form of a projection or rib 25 on a surface of the respective lever 20, 21 facing the container 30. The projection 25 is formed as an integral part of the respective lever 20, 21 by being moulded as a part of the lever 20, 21.

Alternatively, the stop could be formed by a component attached to the lever or could be a recess formed in a surface of the respective lever facing the container with which the end portion of the elongate member may be engaged.

In any event the stop 25 is arranged to prevent sliding of the elongate members 24 beyond a certain position along the length of each lever 20, 21 and are used to transfer load from each lever 20, 21 to the elongate members 24.

The elongate members 24 are formed as an integral part of the collar 40 and as shown in FIG. 1 there are two elongate members 24 interposed between each lever 20, 21 and the collar 40.

As is best understood with reference to FIGS. 2 and 3 the container 30 has a longitudinal axis X-X and each elongate member 24 has a longitudinal axis Y-Y extending between the position of connection ‘PC’ to the collar 40 and the position of interaction ‘PI’ with the respective lever 20, 21. The longitudinal axis Y-Y of each elongate member 24 is arranged at an included angle θ with respect to the longitudinal axis X-X of the container 30 such that the respective elongate member 24 diverges away from the longitudinal axis X-X of the container as it extends from the position of connection ‘PC’ to the collar 40 to the position of interaction ‘PI’ with the respective lever 20, 21.

When the or each lever 20, 21 is moved to cause the container 30 to be moved towards the nozzle 11, the included angle θ between the longitudinal axis Y-Y of each elongate member 24 and the longitudinal axis X-X of the container 30 is reduced as is shown in FIG. 3. This is because when each lever 20, 21 is moved to cause the container 30 to be moved towards the nozzle 11, each elongate member 24 associated therewith is subjected to elastic bending. That is to say the elongate members are bent but when the applied load is released they return to their normal straight condition.

FIG. 4 shows an alternative form of collar 40a and elongate members 24a in which each of the elongate members 24a is formed by a strip or leaf of resilient flexible material. The collar 40a and the elongate members 24a are formed as a single integral part.

Referring to FIG. 2 if a force F1 is applied to the lever 20 where shown then this will result in a force F2 being transferred to the end of the two elongate members 24 from the project 25. Because of the angle at which the elongate members 24 are positioned the two elongate members 24 transmit a force F3 to the collar 40 and once again because of the angle at which this force is applied the force F3 results in a force F4 being transmitted along the axis X-X of the container 30 to move the container in the direction of the nozzle so as to actuate the pump.

Given the angles and geometry shown on FIG. 2 an input force F1 of 20 Newtons will result in a output force F4 of 29.3 Newtons.

However, due to the change in the angles which occurs as the levers 20, 21 are squeezed together, the same input force F1 of 20N will result in an output force F4 of 65.3N being applied to the container 30 at the end of the delivery stroke as shown in FIG. 3.

This increase in mechanical ratio is useful as it ensures that when a user applies a force to the levers 20, 21a positive movement of the container occurs resulting in a short but powerful spraying action.

Operation of the fluid dispensing device is as follows.

FIG. 5 shows the levers 20, 21 in a ready for use position in which the levers 20, 21 are used to hold the fluid discharge device 8 within the housing 9. In this position the end portions of the elongate members 24 rest upon the stops 25.

If required, the container 30 could additionally be slidably engageable with one or is more support structures (not shown) to assist with the location and retention of the fluid discharge device 8 in the housing 9.

If a user then grasps the fluid dispensing device 5 by the two levers 20, 21 then provided only a light pressure is applied to the levers 20, 21 no fluid will be discharged and the user is able to manoeuvre the dispensing nozzle 11 of the fluid dispensing device 5 into the body orifice into which fluid is required to be dispensed. This is because of the presence of static friction between the pivot pins 23 and the levers 20, 21.

If the user then squeezes the two levers 20, 21 together with increasing force the static friction will be overcome and the interaction of the elongate members 24 with the projections 25 will then cause a force to be transmitted to the collar 40 and the container 30 will be moved rapidly towards the nozzle 11. During this part of the operation the elongate members will be subject to elastic bending as the rotational movement of the levers 20, 21 causes the projections 25 on each lever 20, 21 to be moved closer together.

Because of the abutment between the end of the delivery tube 31 and the annular abutment 17, movement of the delivery tube 31 in the same direction is not possible. The effect of this is to cause the container 30 to move relative to the delivery tube 31 causing the delivery tube 31 to push the plunger into the pump casing thereby moving the piston of the pump in the cylinder. This causes fluid to be expelled from the cylinder into the delivery tube 31.

The fluid forced into the delivery tube 16 is then transferred into the orifice 15 from where it is expelled as a fine spray into the body orifice.

Upon releasing the pressure applied to the levers 20, 21 the delivery tube 31 is urged out of the pump casing by the internal return spring and by the natural reaction of the elongate members to return to a straight form and causes fluid to be drawn up the pick-up tube to re-fill the cylinder.

The actuating procedure can then be repeated until all of the fluid in the container has been used. However, only one or two doses of fluid are normally administered at a time.

When the container is empty a new fluid discharge device 8 is loaded into the housing 9 thereby restoring the fluid dispensing device 5 into a useable condition.

With reference to FIGS. 6 to 10 there is shown a second embodiment of a fluid dispensing device for spraying a fluid into a body cavity which is in many respects similar to that previously described.

With reference to FIG. 5 there is shown a first arrangement in accordance with the second embodiment.

The fluid dispensing device 105 comprising a body structure including a housing 109, a nozzle 111 extending out from an upper end of the housing for insertion into a body cavity, a fluid discharge device 108 moveably housed within the housing 109, the fluid discharge device 108 comprising a container 130 having a neck 129 at one end for storing the fluid to be dispensed and a compression pump having a suction inlet located within the container 130 and a discharge outlet 131 for transferring fluid from the pump to the nozzle 111 and at least one lever 120 to apply a force to an actuating means used to move the container 130 towards the nozzle 111 so as to actuate the pump. The lever 120 is pivotally supported at a lower end within the housing 109 and the actuating means is connected to the neck 129 of the container 130 by a collar 140 engaged with the neck 129 of the container 130.

In more detail, the body structure comprises of a two-part plastic housing 109 and a plastic body member 106 both of which are moulded from a suitable plastic material such as polypropylene. The nozzle 111 is formed as an integral part of the body member 106 and the body member 106 is fastened to the housing 109 so that the nozzle 111 projects from the upper end of the housing 109.

A protective end cap 107 for the nozzle 111 is pivotally connected to the body member 106 and has an inner surface for engagement with the body 106 to protect the dispensing nozzle 111.

The housing 109 has an aperture formed in a side wall 114 from which, in use, a part of the lever 120 projects. The part of the lever 120 which projects from the aperture is a ribbed finger grip 146.

The discharge outlet from the pump is in the form of a tubular delivery tube 131 and a tubular guide in the form of an outlet tube 116 is formed within the nozzle 111 to align and locate the delivery tube 131 correctly with respect to the nozzle 111.

An annular abutment 117 is formed at the end of the outlet tube 116. The annular abutment 117 defines the entry to an orifice 115 through which fluid can flow in use and is arranged for abutment with an end of the delivery tube 131.

The fluid discharge device 108 is in most respects conventional and will only be described briefly herein.

The fluid discharge device 108 has a hollow container 130 defining a reservoir containing several doses of the fluid to be dispensed and a compression pump attached to one end of the container 130.

The container 130 as shown is made from glass however it will be appreciated that it could be made from other translucent or transparent materials such as plastic.

The pump includes a plunger (not shown) slidingly engaged within a pump casing which defines a chamber (not shown) sized to accommodate a single dose of fluid. The plunger is attached to the tubular delivery tube 131 which is arranged to extend from one end of the pump for co-operation with the outlet tube 116 of the dispensing nozzle 111. The plunger includes a piston (not shown) slidably supported in the chamber formed in the pump casing.

The fluid is discharged through a discharge channel defined by the tubular delivery tube 131 into the orifice 115 of the dispensing nozzle 111.

The size of chamber is such that it accommodates a single dose of fluid, the diameter of the chamber and piston combined with the stroke of the plunger being such that a full stroke of the plunger in the chamber will produce a change in volume equal to a single dose of fluid.

The pump casing is connected to the container 130 such that when the piston is moved by an internal return spring (not shown) into a start position a new dose of fluid is drawn into the cylinder via the suction inlet in the form of a pick-up tube from the container 130 ready for discharge.

The collar 140 can be connected to the neck 129 of the container 130 by any convenient means but it is preferred to use a snap connection in which the collar 140 has a groove 141 into which the collar 140 is snap fitted. The collar 140 has a slit 142 in one side which allows it to be pushed onto the neck 129 and engage with the groove 141. The use of a snap fastened collar is advantageous in that it allows for the use of a standard fluid discharge device.

The actuating means is a resilient flexible member 124 in the form of a leaf spring connected to an upper end of the lever 120 so as to hold the resilient flexible member 124 in an upwardly bowed state. However, it will be appreciated that more than one resilient flexible member could be used if required.

The lower end of the lever 120 is pivotally connected to the housing 109 by means of a pivot pin 123.

The resilient flexible member 124 is operably connected to the neck 129 of the container 130 by abutment of an upper surface 126 of the resilient flexible member 124 against a lower surface 127 of the collar 140 which is attached to the neck 129 of the container 130.

A stop means 125 is provided to limit rotational movement of the lever 120 away from the container 130 so as to maintain the resilient flexible member 124 in a bowed state. The stop means 125 takes the form of one edge of the aperture through which the lever 120 projects.

The lever 120 is pivotally supported at a lower end within the housing 109 and the resilient flexible member 124 is connected at one end to the upper end of the lever 120 by engagement with a groove 134 formed in the lever 120 and is connected at an opposite end to part of the body structure of the fluid dispensing device 105 in the form of the housing 109 which has a groove 135 formed therein with which the resilient flexible member 124 is engaged.

It will be appreciated that if removed from the fluid dispensing device 105 the resilient flexible member will return to a flat planar shape as it undergoes no plastic deformation during use but only elastic deformation.

The stop 125 is positioned such that when the lever 120 is displaced fully from the container 130 so as to rest against the stop 125 the linear distance between the upper end of the lever 120 and the position of connection of the resilient flexible member 124 to the housing 109 is less than the un-bowed length of the resilient flexible member 124. This ensures that the flexible member never returns to a flat shape. This is important because the resilient flexible member must be bowed upwardly to function correctly and if it were to be fully released there is a possibility that upon re-applying a load to it would bow downwardly.

When the lever 120 is moved towards the container 130 so as to cause the container 130 to be moved towards the nozzle 111, the radius of curvature ‘R’ of the bowed resilient flexible member 124 is reduced and the collar 140 is moved upwardly.

The fluid dispensing device 105 further includes the end cap 107 to protect the nozzle 111 and the upper end of the lever 120 is adapted to automatically open the end cap 107 when the lever 120 is moved to cause the container 130 to be moved towards the nozzle 111.

The lever 120 is adapted by means of a toothed portion 148 formed on the upper end of the lever 120 for engagement with a complementary toothed portion 149 formed on the end cap 107. As the lever 120 is rotated about its lower end towards the container 130 the engagement of the two toothed portions 148, 149 causes the end cap 107 to be flipped back into an open position as shown in FIG. 6.

Operation of the fluid dispensing device 105 is as follows.

After inserting a fluid discharge device 108 into the housing 109 the fluid dispensing device is ready for use and the lever 120 will be resting against the end stop 125.

To use the fluid dispensing device 105 a user must first grasp the fluid dispensing device 105 so that contact is made with the lever 120 and in particular with the ribbed finger grip 146.

Provided that only a light pressure is applied to the lever 120 no fluid will be discharged and the user is able to manoeuvre the dispensing nozzle 111 of the fluid dispensing device 105 into a body orifice such as a nasal cavity into which fluid is required to be dispensed. This is because of the presence of some free travel between the collar 140 and the groove 141. Any initial movement of the lever 120 will however cause the end cap 107 to be opened.

If the user then exerts more force upon the lever 120 the free play will eventually be exceeded and the interaction of the resilient flexible member 124 upon the collar 140 will then cause the container 130 to be moved rapidly towards the nozzle 111. It will be appreciated that as the lever 120 is rotated the linear distance between the ends of the resilient flexible member 124 is reduced and therefore it must bow to a greater degree because it is of fixed length.

Because of the abutment between the end of the delivery tube 131 and the annular abutment 117 movement of the delivery tube 131 in the same direction is prevented and therefore the delivery tube 131 is pushed into the container 130 causing the plunger to be pushed into the pump casing, thereby moving the piston of the pump in the cylinder. This causes fluid to be expelled from the cylinder into the delivery tube 131 and then into the orifice 115 from where it is expelled as a fine spray into the body orifice.

Upon releasing the pressure applied to the levers 120, the delivery tube 131 is urged out of the pump casing by the internal return spring which causes fluid to be drawn up the pick-up tube to re-fill the cylinder. The resilient flexible member 124 will try to assume is least deformed state and so will urge the lever 120 back upon its stop 125 as soon as the force is removed from the lever 120.

The actuating procedure can then be repeated until all of the fluid in the container has been used. However, only one or two doses of fluid are normally administered at a time.

When the container 130 is empty a new fluid discharge device 108 is loaded into the body member 106 thereby restoring the fluid dispensing device 105 into a useable condition.

With particular reference to FIGS. 7 to 10 there is shown a second arrangement according to the second embodiment of the invention which utilises the same principle as previously described.

The fluid dispensing device 205 comprising a body structure including a housing 209, a nozzle 211 extending out from an upper end of the housing 209 for insertion into a body cavity, a fluid discharge device 208 moveably housed within the housing 209, the fluid discharge device 208 comprising a container 230 having a neck 229 at one end for storing the fluid to be dispensed and a compression pump having a suction inlet located within the container 230 and a discharge outlet 231 for transferring fluid from the pump to the nozzle 211 and at least one lever 220, 221 to apply a force to an actuating means used to move the container 230 towards the nozzle 211 so as to actuate the pump.

Each of the levers 220, 221 is pivotally supported at a lower end within the housing 209 and the actuating means is connected to the neck 229 of the container 230 by a collar 240 engaged with the neck 229 of the container 230.

In more detail, the body structure comprises of a plastic housing 209 and a plastic body member 206 both of which are moulded from a suitable plastic material such as polypropylene. The nozzle 211 is formed as an integral part of the body member 206 and the body member 206 is fastened to the housing 209 so that the nozzle 211 projects from the upper end of the housing 209.

The housing 209 has an aperture formed in both side walls from which, in use, a part of one of the two levers 220, 221 projects.

The discharge outlet from the pump is in the form of a tubular delivery tube 231 and a tubular guide in the form of an outlet tube 216 is formed within the nozzle 211 to align and locate the delivery tube 231 correctly with respect to the nozzle 211.

An annular abutment 217 is formed at the end of the outlet tube 216. The annular abutment 217 defines the entry to an orifice 215 through which fluid can flow in use and is arranged for abutment with an end of the delivery tube 231.

The fluid discharge device 208 is in most respects conventional and is as previously described having a hollow container 230 defining a reservoir containing several doses of the fluid to be dispensed and a compression pump attached to one end of the container 230. A pump is fitted in the container 230 to pump fluid out of the container 230 via the delivery tube 231 into the orifice 215 of the dispensing nozzle 211.

The collar 240 is connected to the neck 229 of the container 230 by any convenient means but it is preferred to use a snap connection in which the collar 240 has a groove 241 into which the collar 240 is snap fitted. The collar 240 has a slit 242 in one side which allows it to be pushed onto the neck 229 and engage with the groove 241. The use of a snap fastened collar is advantageous in that it allows for the use of a standard fluid discharge device.

Each of the two levers 220, 221 is pivotally supported at a lower end within the housing 209 by means of pivot pins 223 formed as part of the levers 220, 221 and engaged with apertures formed in part of the housing 209.

The resilient flexible member 224 is connected at one end to the upper end of one of the two levers 220, 221 and is connected at an opposite end to the upper end of the other of the two levers 220, 221.

As best seen with reference to FIGS. 9 and 10, the resilient flexible member 224 and the two levers 220, 221 is formed as a single integral part.

The levers 220, 221 and the resilient flexible member 224 are moulded as one part and when removed from the housing 209 the resilient flexible member returns to a flat or planar shape as shown in FIG. 10.

An aperture 250 is formed in the resilient flexible member to allow it to be engaged with the neck 229 of the container 230.

The resilient flexible member 224 is operably connected to the neck 229 of the container 230 by abutment of an upper surface 226 of the resilient flexible member 224 against a lower surface 227 of the collar 240 which is attached to the neck 229 of the container 230.

A stop (not shown) formed by an edge of the aperture through which each lever 220, 221 extends is positioned such that when the two levers 220, 221 are displaced fully from the container 230, so as to rest against their respective stops, the linear distance between the upper ends of the two levers 220, 221 is less than the un-bowed length of the resilient flexible member 224.

This ensures that the flexible member never returns to a flat shape. This is important because the resilient flexible member must be bowed upwardly to function correctly and if it were to be fully released there is a possibility that upon re-applying a load to it would bow downwardly. It will be appreciated that other means could be used to maintain the resilient flexible member in a bowed upwardly state. For example, a stop can be positioned mid-span upon which a lower surface of the resilient member rests when the levers are not being operated.

When the two levers 220, 221 are moved towards the container 230 so as to cause the container 230 to be moved towards the nozzle 211, the radius of curvature of the bowed resilient flexible member 224 is reduced and the collar 240 is moved upwardly. This can be seen by comparing the radius ‘r1’ on FIG. 7 with the radius ‘r2’ on FIG. 8.

As before when the two levers 220, 221 are squeezed together by a user then the resilient flexible member 224 is forced to adopt a more deformed or bowed state due to the fact that the distance between the upper ends of the levers 220, 221 reduces but the length of the resilient flexible member 224 is fixed. This causes the resilient flexible member 224 to bow upwardly thereby pushing the collar 240 upwardly.

Because the outlet tube 231 is already touching the annular abutment 217 it cannot move upwardly and so the net effect is that the outlet tube 231 is pushed into the end of the container 230 causing the pump to be actuated and fluid to be ejected out of the discharge tube 231 via the orifice 215 in the form of a spray.

With reference to FIGS. 11 to 20 there is shown a third embodiment of a fluid dispensing device according to the first aspect of the invention.

With particular reference to FIGS. 11 to 14 there is shown a first arrangement according to the third embodiment

The fluid dispensing device 305 comprises of a body structure including a housing 309, a nozzle 311 extending out from an upper end of the housing 309 for insertion into a body cavity, a fluid discharge device 308 moveably housed within the housing 309, the fluid discharge device 308 comprising a container 330 having a neck 329 at one end for storing the fluid to be dispensed and a compression pump having a suction inlet located within the container 330 and a discharge outlet 331 for transferring fluid from the pump to the nozzle 311 and at least one lever 320, 321 to apply a force to an actuating means used to move the container 330 towards the nozzle 311 so as to actuate the pump.

The lever two levers 320, 321 are pivotally supported at a lower end within the housing 309 and the actuating means is connected to the neck 329 of the container 330 by a collar 340 engaged with the neck 329 of the container 330.

In more detail, the lower end of each lever 320 321 is pivotally connected to the housing 309 by means of a pivot pin 323 and the body structure comprises of a housing 309 and a plastic body member 306 both of which are moulded from a suitable plastic material such as polypropylene. The nozzle 311 is formed as an integral part of the body member 306 and the body member 306 is fastened to the housing 309 so that the nozzle 311 projects from the upper end of the housing 309. The housing 309 has an aperture 328 formed in a front wall to check the level of the fluid in the container 330 and may have a similar aperture in a rear wall.

A protective end cap 307 for the nozzle 311 has an inner surface for engagement with the body 306 to protect the dispensing nozzle 311.

The body 306 has an aperture formed in each side wall 314 from which, in use, a part of a respective one of the two levers 320 projects. The part of the lever 320 which projects from each aperture is a ribbed finger grip 346. The finger grip is positioned near an upper end of each lever 320, 321 so as to maximise the distance between the position where each lever 320, 321 is pivotally connected and the position where a force will be applied by a user. This maximises the mechanical advantage of the levers 320, 321.

The discharge outlet from the pump is in the form of a tubular delivery tube 331 and a tubular guide in the form of an outlet tube 316 is formed within the nozzle 311 to align and locate the delivery tube 331 correctly with respect to the nozzle 311.

An annular abutment 317 is formed at the end of the outlet tube 316. The annular abutment 317 defines the entry to an orifice 315 through which fluid can flow in use and is arranged for abutment with an end of the delivery tube 331.

The fluid discharge device 308 is in most respects conventional and will only be described briefly herein.

The fluid discharge device 308 has a hollow container 330 defining a reservoir containing several doses of the fluid to be dispensed and a compression pump attached to one end of the container 330.

The container 330 as shown is made from a translucent or transparent material such as plastic or glass.

The pump includes a plunger (not shown) slidingly engaged within a pump casing which defines a chamber (not shown) sized to accommodate a single dose of fluid. The plunger is attached to the tubular delivery tube 331 which is arranged to extend from one end of the pump for co-operation with the outlet tube 316 of the dispensing nozzle 311. The plunger includes a piston (not shown) slidably supported in the chamber formed in the pump casing.

The fluid is discharged through a discharge channel defined by the tubular delivery tube 331 into the orifice 315 of the dispensing nozzle 311.

The size of chamber is such that it accommodates a single dose of fluid, the diameter of the chamber and piston combined with the stroke of the plunger being such that a full stroke of the plunger in the chamber will produce a change in volume equal to a single dose of fluid.

The pump casing is connected to the container 330 such that when the piston is moved by an internal return spring (not shown) into a start position a new dose of fluid is drawn into the cylinder via the suction inlet in the form of a pick-up tube from the container 330 ready for discharge.

The collar 340 can be connected to the neck 329 of the container 330 by any convenient means but it is preferred to use a snap connection because it allows for the use of a standard fluid discharge device.

The fluid discharge device 305 has a longitudinal axis X-X and the actuating means comprises of at least one abutment surface 322 formed on the collar 340 against which at least one actuating surface 324a, 324b formed at an upper end of each lever 320, 321 is arranged to react. At least one of the or each actuating surface 324a, 324b and the or each abutment surface 322 is arranged at an angle to the longitudinal axis X-X of the fluid discharge device 305 so as to convert a force applied to the levers substantially transversely to the longitudinal axis X-X of the fluid discharge device 305 into a force along the longitudinal axis X-X of the fluid discharge device.

In the embodiment shown there are four abutment surfaces 322 arranged at an angle to the longitudinal axis X-X of the fluid discharge device 305 and there are four actuating surfaces 324a, 324b arranged at an angle to the longitudinal axis X-X of the fluid discharge device 305

Each of the four abutment surfaces 322 formed on the collar 340 is located for co-operation with a respective one of two actuating surfaces 324a, 324b formed on each of the two levers 320, 321 and is formed as an integral part of the collar 340.

Each of the levers 320, 321 is U-shaped in cross-section and has first and second flanges 325a, 325b joined together by a bridging portion 326.

The first flange 325a has an end portion forming a first actuating surface 324a and the second flange 325b has an end portion forming a second actuating surface 324b.

Operation of the fluid dispensing device 305 is as follows.

After inserting a fluid discharge device 308 into the housing 309 the fluid dispensing device is ready for use and the levers 320, 321 will be in the position shown in FIGS. 11, 12 and 13.

To use the fluid dispensing device 305 a user must first grasp the fluid dispensing device 305 so that contact is made with the levers 320, 321 and in particular with the ribbed finger grips 346.

Provided that only a light pressure is applied to the lever 320 no fluid will be discharged and the user is able to manoeuvre the dispensing nozzle 311 of the fluid dispensing device 305 into a body orifice such as a nasal cavity into which fluid is required to be dispensed. This is because of the presence of the presence of a pre-load mechanism in the form of two ribs 370 formed on an inner surface of the body 306 against which the end portions of each lever 320, 321 abut.

If the user then squeezes the two levers 320, 321 together with increasing force the load required to make the levers 320, 321 ride over the ribs 370 will eventually be exceeded and the interaction of the actuating surfaces 324a, 324b upon the inclined abutment surfaces 322 will then cause the container 330 to be moved rapidly towards the nozzle 311.

Because of the abutment between the end of the delivery tube 331 and the annular abutment 317 movement of the delivery tube 331 in the same direction is prevented and therefore the delivery tube 331 is pushed into the container 330 causing the plunger to be pushed into the pump casing, thereby moving the piston of the pump in the cylinder. This causes fluid to be expelled from the cylinder into the delivery tube 331 and then into the orifice 315 from where it is expelled as a fine spray into the body orifice.

Upon releasing the pressure applied to the levers 320, the delivery tube 331 is urged out of the pump casing by the internal return spring which causes fluid to be drawn up the pick-up tube to re-fill the cylinder. The actuating surfaces 324a, 324b will slide along the abutment surfaces 322 in the opposite direction returning the levers 320, 321 to a ready for use position as shown in FIGS. 11, 12 and 13. If required an additional return spring can be provided between the neck of the container and the inner surface of the body.

The actuating procedure can then be repeated until all of the fluid in the container has been used. However, only one or two doses of fluid are normally administered at a time.

When the container 330 is empty a new fluid discharge device 308 is loaded into the body member 306 thereby restoring the fluid dispensing device 305 into a useable condition.

With particular reference to FIGS. 15 to 20 there is shown a second arrangement according to the third embodiment.

The fluid dispensing device 405 comprises of a body structure including a housing 409, a nozzle 411 extending out from an upper end of the housing 409 for insertion into a body cavity, a fluid discharge device 408 moveably housed within the housing 409, the fluid discharge device 408 comprising a container 430 having a neck 429 at one end for storing the fluid to be dispensed and a compression pump having a suction inlet located within the container 430 and a discharge outlet 431 for transferring fluid from the pump to the nozzle 411 and at least one lever 420, 421 to apply a force to an actuating means used to move the container 430 towards the nozzle 411 so as to actuate the pump.

The lever two levers 420, 421 are pivotally supported at a lower end within the housing 409 and the actuating means is connected to the neck 429 of the container 430 by a collar 440 engaged with the neck 429 of the container 430.

In more detail, the lower end of each lever 420 421 is pivotally connected to the housing 409 by means of a flexible strap 423 joining the lower ends of the two levers 420, 421. The body structure comprises of a housing 409 and a plastic body member 406 both of which are moulded from a suitable plastic material such as polypropylene. The nozzle 411 is formed as an integral part of the body member 406 and the body member 406 is fastened to the housing 409 so that the nozzle 411 projects from the upper end of the housing 409. The housing 409 has a front wall 412, a rear wall 413 and two opposing side walls 414 and at least one of the front wall and the rear wall may have an aperture therein to view the level of the fluid in the container 430, and as shown the housing has apertures 428 formed in both front and rear walls to check the level of the fluid in the container 430.

A protective end cap 407 for the nozzle 411 has an inner surface for engagement with the body 406 to protect the dispensing nozzle 411 and is connected to the body by a flexible strap.

The housing has two apertures 427 formed therein from each of which, in use, a part of a respective one of the levers 420, 421 projects. Therebeing an aperture 427 formed in each side wall 414 from which, in use, a part of a respective one of the two levers 420 projects. The part of the lever 420 which projects from each aperture is a ribbed finger grip 446. The finger grip is positioned near an upper end of each lever 420, 421 so as to maximise the distance between the position where each lever 420, 421 is pivotally connected and the position where a force will be applied by a user. This maximises the mechanical advantage of the levers 420, 421.

The discharge outlet from the pump is in the form of a tubular delivery tube 431 and a tubular guide in the form of an outlet tube 416 is formed within the nozzle 411 to align and locate the delivery tube 431 correctly with respect to the nozzle 411.

An annular abutment 417 is formed at the end of the outlet tube 416. The annular abutment 417 defines the entry to an orifice 415 through which fluid can flow in use and is arranged for abutment with an end of the delivery tube 431.

The fluid discharge device 408 is in most respects conventional and will only be described briefly herein.

The fluid discharge device 408 has a hollow container 430 defining a reservoir containing several doses of the fluid to be dispensed and a compression pump attached to one end of the container 430.

The container 430 as shown is made from a translucent or transparent material such as plastic or glass.

The pump includes a plunger (not shown) slidingly engaged within a pump casing which defines a chamber (not shown) sized to accommodate a single dose of fluid. The plunger is attached to the tubular delivery tube 431 which is arranged to extend from one end of the pump for co-operation with the outlet tube 416 of the dispensing nozzle 411. The plunger includes a piston (not shown) slidably supported in the chamber formed in the pump casing.

The fluid is discharged through a discharge channel defined by the tubular delivery tube 431 into the orifice 415 of the dispensing nozzle 411.

The size of chamber is such that it accommodates a single dose of fluid, the diameter of the chamber and piston combined with the stroke of the plunger being such that a full stroke of the plunger in the chamber will produce a change in volume equal to a single dose of fluid.

The pump casing is connected to the container 430 such that when the piston is moved by an internal return spring (not shown) into a start position a new dose of fluid is drawn into the cylinder via the suction inlet in the form of a pick-up tube from the container 430 ready for discharge.

The collar 440 can be connected to the neck 429 of the container 430 by any convenient means.

The fluid discharge device 405 has a longitudinal axis X-X and the actuating means comprises of at least one abutment surface 422 formed on the collar 440 against which at least one actuating surface 424a, 424b formed at an upper end of each lever 420, 421 is arranged to react. At least one of the or each actuating surface 424a, 424b and the or each abutment surface 422 is arranged at an angle to the longitudinal axis X-X of the fluid discharge device 405 so as to convert a force applied to the levers substantially transversely to the longitudinal axis X-X of the fluid discharge device 405 into a force along the longitudinal axis X-X of the fluid discharge device.

In the embodiment shown there are two abutment surfaces 422 arranged at an angle to the longitudinal axis X-X of the fluid discharge device 405 and there are four actuating surfaces 424a, 424b, each of which is in the form of a curved surface.

Each of the four abutment surfaces 422 formed on the collar 440 is located for co-operation with two of the actuating surfaces 424a, 424b formed on each of the two levers 420, 421 and is formed as an integral part of the collar 440.

Each of the levers 420, 421 is U-shaped in cross-section and has first and second flanges 425a, 425b joined together by a bridging portion 426.

The first flange 425a has an end portion forming a first actuating surface 424a and the second flange 425b has an end portion forming a second actuating surface 424b.

Operation of the fluid dispensing device 405 is as follows.

After inserting a fluid discharge device 408 into the housing 409 the fluid dispensing device is ready for use and the levers 420, 421 will be in the position shown in FIGS. 15, 16, 18, 19 and 20.

To use the fluid dispensing device 405 a user must first grasp the fluid dispensing device 405 so that contact is made with the levers 420, 421 and in particular with the ribbed finger grips 446.

Provided that only a light pressure is applied to the lever 420 no fluid will be discharged and the user is able to manoeuvre the dispensing nozzle 411 of the fluid dispensing device 405 into a body orifice such as a nasal cavity into which fluid is required to be dispensed. This is because of the presence of a pre-load mechanism (not shown) which prevents movement of each lever 420, 421 until a pre-determined load has been overcome.

If the user then squeezes the two levers 420, 421 together with increasing force the pre-determined load will be overcome and the interaction of the actuating surfaces 424a, 424b upon the inclined abutment surfaces 422 will then cause the container 430 to be moved rapidly towards the nozzle 411. The provision of the pre-load mechanism ensures that the levers move rapidly thereby ensure a short sharp spray is produced having a large number of atomised particles.

Because of the abutment between the end of the delivery tube 431 and the annular abutment 417 movement of the delivery tube 431 in the same direction is prevented and therefore the delivery tube 431 is pushed into the container 430 causing the plunger to be pushed into the pump casing, thereby moving the piston of the pump in the cylinder. This causes fluid to be expelled from the cylinder into the delivery tube 431 and then into the orifice 415 from where it is expelled as a fine spray into the body orifice.

Upon releasing the pressure applied to the levers 420, the delivery tube 431 is urged out of the pump casing by the internal return spring which causes fluid to be drawn up the pick-up tube to re-fill the cylinder. The actuating surfaces 424a, 424b will slide along the abutment surfaces 422 in the opposite direction returning the levers 420, 421 to a ready for use position as shown in FIGS. 11, 12 and 13. If required an additional return spring can be provided between the neck of the container and the inner surface of the body.

The actuating procedure can then be repeated until all of the fluid in the container has been used. However, only one or two doses of fluid are normally administered at a time.

When the container 430 is empty a new fluid discharge device 408 is loaded into the body member 406 thereby restoring the fluid dispensing device 405 into a useable condition.

The term ‘neck of the container’ as meant herein is the end of the container from which extends the pump delivery tube. It will be appreciated that the collar could be directly connected to the neck of the container itself or could be attached to a flange or other member used to fix the pump to the neck of the container.

It will be appreciated that by connecting the or each lever to the container at the opposite end to where the lever is pivotally supported provides the maximum leverage or mechanical advantage.

It is envisaged that the fluid dispensing device could be sold as two separate items. A fluid discharge device could be sold for fitment into a housing assembly and a housing assembly could be sold into which a fluid discharge device could be fitted.

It will be understood that the present disclosure is for the purpose of illustration only and the invention extends to modifications, variations and improvements thereto.

For example although the two embodiments describe in detail an arrangement in which the two levers act upon a base portion of the container and push it towards the nozzle it would also possible to arrange for the two leavers to pull the container towards the nozzle. The invention is not therefore to be construed as being limited solely to a device that pushes the container towards the nozzle.

It may be appreciated that any of the parts of the dispenser device which contact the fluid may be coated with materials such as fluoropolymer materials (e.g. PTFE or FEP) which reduce the tendency of medicament to adhere thereto. Any movable parts may also have coatings applied thereto which enhance their desired movement characteristics. Frictional coatings may therefore be applied to enhance frictional contact and lubricants (e.g. silicone oil) used to reduce frictional contact as necessary.

Administration of medicament may be indicated for the treatment of mild, moderate or severe acute or chronic symptoms or for prophylactic treatment. It will be appreciated that the precise dose administered will depend on the age and condition of the patient, the particular medicament used and the frequency of administration and will ultimately be at the discretion of the attendant physician. Embodiments are envisaged in which combinations of medicaments are employed.

Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (eg as the sodium salt), ketotifen or nedocromil (eg as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (eg as the dipropionate ester), fluticasone (eg as the propionate ester), flunisolide, budesonide, rofleponide, mometasone (eg as the furoate ester), ciclesonide, triamcinolone (eg as the acetonide), 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester or 6α, 9α-Difluoro-1 7α-[(2-furanylcarbonyl)oxy]-11β-hydroxy-1 6α-methyl-3-oxo-androsta-1,4-diene-17β-carbothioic acid S-fluoromethyl ester; antitussives, e.g., noscapine; bronchodilators, e.g., albuterol (eg as free base or sulphate), salmeterol (eg as xinafoate), ephedrine, adrenaline, fenoterol (eg as hydrobromide), formoterol (eg as fumarate), isoprenaline, metaproterenol, phenylephrine, phenylpropanolamine, pirbuterol (eg as acetate), reproterol (eg as hydrochloride), rimiterol, terbutaline (eg as sulphate), isoetharine, tulobuterol or 4-hydroxy-7-[2-[[2-[[3-(2-phenylethoxy)propyl]sulfonyl]ethyl]amino]ethyl-2 (3H)-benzothiazolone; PDE4 inhibitors eg cilomilast or roflumilast; leukotriene antagonists eg montelukast, praniukast and zafirlukast; [adenosine 2a agonists, eg 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g. as maleate)]*; [α4 integrin inhibitors eg (2S)-3-[4-({[4-(aminocarbonyl)-1-piperidinyl]carbonyl}oxy)phenyl]-2-[((2S)-4-methyl-2-{[2-(2-methylphenoxy) acetyl]amino}pentanoyl)amino]propanoic acid (e.g as free acid or potassium salt)]*, diuretics, e.g., amiloride; anticholinergics, e.g., ipratropium (eg as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagons. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament and/or to minimise the solubility of the medicament in the propellant.

Preferably, the medicament is an anti-inflammatory compound for the treatment of inflammatory disorders or diseases such as asthma and rhinitis.

In one aspect, the medicament is a glucocorticoid compound, which has anti-inflammatory properties. One suitable glucocorticoid compound has the chemical name: 6α,9α-Difluoro-17α-(1-oxopropoxy)-11β-hydroxy-16α-methyl-3-oxo-androsta-1,4-diene-17β-carbothioic acid S-fluoromethyl ester (fluticasone propionate). Another suitable glucocorticoid compound has the chemical name: 6α,9α-difluoro-17α-[(2-furanylcarbonyl)oxy]-11β-hydroxy-16α-methyl-3-oxo-androsta-1,4-diene-17β-carbothioic acid S-fluoromethyl ester. A further suitable glucocorticoid compound has the chemical name: 6α,9α-Difluoro-11β-hydroxy-16α-methyl-17α-[(4-methyl-1,3-thiazole-5-carbonyl)oxy]-3-oxo-androsta-1,4-diene-17β-carbothioic acid S-fluoromethyl ester.

Other suitable anti-inflammatory compounds include NSAIDs e.g. PDE4 inhibitors, leukotriene antagonists, iNOS inhibitors, tryptase and elastase inhibitors, beta-2 integrin antagonists and adenosine 2a agonists.

The medicament is formulated as any suitable fluid formulation, particularly a solution (e.g. aqueous) formulation or a suspension formulation, optionally containing other pharmaceutically acceptable additive components.

Suitable formulations (e.g. solution or suspension) may be stabilised (e.g. using hydrochloric acid or sodium hydroxide) by appropriate selection of pH. Typically, the pH will be adjusted to between 4.5 and 7.5, preferably between 5.0 and 7.0, especially around 6 to 6.5.

Suitable formulations (e.g. solution or suspension) may comprise one or more excipients. By the term “excipient”, herein, is meant substantially inert materials that are nontoxic and do not interact with other components of a composition in a deleterious manner including, but not limited to, pharmaceutical grades of carbohydrates, organic and inorganic salts, polymers, amino acids, phospholipids, wetting agents, emulsifiers, surfactants, poloxamers, pluronics, and ion exchange resins, and combinations thereof.

Suitable carbohydrates include monosaccharides include fructose; disaccharides, such as, but not limited to lactose, and combinations and derivatives thereof; polysaccharides, such as, but not limited to, cellulose and combinations and derivatives thereof; oligosaccharides, such as, but not limited to, dextrins, and combinations and derivatives thereof; polyols, such as but not limited to sorbitol, and combinations and derivatives thereof.

Suitable organic and inorganic salts include sodium or calcium phosphates, magnesium stearate, and combinations and derivatives thereof.

Suitable polymers include natural biodegradable protein polymers, including, but not limited to, gelatin and combinations and derivatives thereof; natural biodegradable polysaccharide polymers, including, but not limited to, chitin and starch, crosslinked starch and combinations and derivatives thereof; semisynthetic biodegradable polymers, including, but not limited to, derivatives of chitosan; and synthetic biodegradable polymers, including, but not limited to, polyethylene glycols (PEG), polylactic acid (PLA), synthetic polymers including but not limited to polyvinyl alcohol and combinations and derivatives thereof;

Suitable amino acids include non-polar amino acids, such as leucine and combinations and derivatives thereof. Suitable phospholipids include lecithins and combinations and derivatives thereof.

Suitable wetting agents, surfactants and/or emulsifiers include gum acacia, cholesterol, fatty acids including combinations and derivatives thereof. Suitable poloxamers and/or Pluronics include poloxamer 188, Pluronic® F-108, and combinations and derivations thereof. Suitable ion exchange resins include amberlite IR120 and combinations and derivatives thereof;

Suitable solution formulations may comprise a solubilising agent such as a surfactant. Suitable surfactants include α-[4-(1,1,3,3-tetramethylbutyl)phenyl]-ω-hydroxypoly(oxy-1,2-ethanediyl) polymers including those of the Triton series e.g. Triton X-100, Triton X-114 and Triton X-305 in which the X number is broadly indicative of the average number of ethoxy repeating units in the polymer (typically around 7-70, particularly around 7-30 especially around 7-10) and 4-(1,1,3,3 tetramethylbutyl)phenol polymers with formaldehyde and oxirane such as those having a relative molecular weight of 3500-5000 especially 4000-4700, particularly Tyloxapol. The surfactant is typically employed in a concentration of around 0.5-10%, preferably around 2-5% w/w based on weight of formulation.

Suitable solution formulations may also comprise hydroxyl containing organic co-solvating agents include glycols such as polyethylene glycols (eg PEG 200) and propylene glycol; sugars such as dextrose; and ethanol. Dextrose and polyethylene glycol (eg PEG 200) are preferred, particularly dextrose. Propylene glycol is preferably used in an amount of no more than 20%, especially no more than 10% and is most preferably avoided altogether. Ethanol is preferably avoided. The hydroxyl containing organic co-solvating agents are typically employed at a concentration of 0.1-20% e.g. 0.5-10%, e.g. around 1-5% w/w based on weight of formulation.

Suitable solution formulations may also comprise solublising agents such as polysorbate, glycerine, benzyl alcohol, polyoxyethylene castor oils derivatives, polyethylene glycol and polyoxyethylene alkyl ethers (e.g. Cremophors, Brij).

Suitable solution formulations may also comprise one or more of the following components: viscosity enhancing agents; preservatives; and isotonicity adjusting agents.

Suitable viscosity enhancing agents include carboxymethylcellulose, veegum, tragacanth, bentonite, hydroxypropylmethylcellulose, hydroxypropylcellulose, hydroxyethylcellulose, poloxamers (eg. poloxamer 407), polyethylene glycols, alginates xanthym gums, carageenans and carbopols.

Suitable preservatives include quaternary ammonium compounds (e.g. benzalkonium chloride, benzethonium chloride, cetrimide and cetylpyridinium chloride), mercurial agents (e.g. phenylmercuric nitrate, phenylmercuric acetate and thimerosal), alcoholic agents (e.g. chlorobutanol, phenylethyl alcohol and benzyl alcohol), antibacterial esters (e.g. esters of para-hydroxybenzoic acid), chelating agents such as disodium edetate (EDTA) and other anti-microbial agents such as chlorhexidine, chlorocresol, sorbic acid and its salts and polymyxin.

Suitable isotonicity adjusting agents act such as to achieve isotonicity with body fluids (e.g. fluids of the nasal cavity), resulting in reduced levels of irritancy associated with many nasal formulations. Examples of suitable isotonicity adjusting agents are sodium chloride, dextrose and calcium chloride.

Suitable suspension formulations comprise an aqueous suspension of particulate medicament and optionally suspending agents, preservatives, wetting agents or isotonicity adjusting agents.

The particulate medicament suitably has a mass mean diameter (MMD) of less than 20 μm, preferably between 0.5-10 μm, especially between 1-5 μm. If particle size reduction is necessary, this may be achieved by techniques such as micronisation and/or microfluidisation.

Suitable suspending agents include carboxymethylcellulose, veegum, tragacanth, bentonite, methylcellulose and polyethylene glycols.

Suitable wetting agents function to wet the particles of medicament to facilitate dispersion thereof in the aqueous phase of the composition. Examples of wetting agents that can be used are fatty alcohols, esters and ethers. Preferably, the wetting agent is a hydrophilic, non-ionic surfactant, most preferably polyoxyethylene (20) sorbitan monooleate (supplied as the branded product Polysorbate 80).

Suitable preservatives and isotonicity adjusting agents are as described above in elation to solution formulations.

The dispensing device herein is suitable for dispensing fluid medicament formulations for the treatment of inflammatory and/or allergic conditions of the nasal passages such as rhinitis e.g. seasonal and perennial rhinitis as well as other local inflammatory conditions such as asthma, COPD and dermatitis.

A suitable dosing regime would be for the patient to inhale slowly through the nose subsequent to the nasal cavity being cleared. During inhalation the formulation would be applied to one nostril while the other is manually compressed. This procedure would then be repeated for the other nostril. Typically, one or two inhalations per nostril would be administered by the above procedure up to three times each day, ideally once daily. Each dose, for example, may deliver 5 μg, 50 μg, 100 μg, 200 μg or 250 μg of active medicament. The precise dosage is either known or readily ascertainable by those skilled in the art.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims.

1. A fluid dispensing device for spraying a fluid into a body cavity comprising
(a) a body structure including a housing,
(b) a nozzle extending out from an upper end of the housing for insertion into a body cavity,
(c) a fluid discharge device moveably housed within the housing, the fluid discharge device comprising
(1) a container for storing the fluid to be dispensed having a neck at one end and a compression pump having
(i) a suction inlet located within the container and
(ii) a discharge outlet extending out from the neck of the container for transferring fluid from the pump to the nozzle and
(iii) at least one lever to apply a force to an actuating means used to move the container towards the nozzle so as to actuate the pump
wherein the or each lever is pivotally supported at a lower end within the housing and the actuating means connects to the neck of the container.

2. A fluid dispensing device as claimed in claim 1 in which the actuating means connects to the neck of the container by a collar engaging with the neck of the container.

3. A fluid dispensing device as claimed in claim 1 in which there are two opposing levers each of which is pivotally supported near a lower end of the housing and is arranged to act upon the actuating means so as to urge the container towards the nozzle when the two levers are squeezed together by a user.

4. A fluid dispensing device as claimed in claim 1 in which the or each lever is pivotally connected to part of the housing.

5. A fluid dispensing device as claimed in claim 2 in which the actuating means comprises at least one elongate member interposed between a position of connection to the collar and a position of interaction with a respective lever.

6. A fluid dispensing device as claimed in claim 5 in which the position of interaction is a position where an end portion of each elongate member reacts against a stop associated with the respective lever.

7. A fluid dispensing device as claimed in claim 6 in which the stop is a projection on a surface of the respective lever facing the container.

8. A fluid dispensing device as claimed in claim 7 in which the projection is formed as an integral part of the respective lever.

9. A fluid dispensing device as claimed in claim 6 which the stop is a recess formed in a surface of the respective lever facing the container with which the end portion of the elongate member is engaged.

10. A fluid dispensing device as claimed in claim 5 in which each elongate member is formed as an integral part of the collar.

11. A fluid dispensing device as claimed in claim 5 in which there are two elongate members interposed between each lever and the collar.

12. A fluid dispensing device of claim 5 in which the container has a longitudinal axis and each elongate member has a longitudinal axis extending between the position of connection to the collar and the position of interaction with the respective lever, the longitudinal axis of each elongate member being arranged at an included angle with respect to the longitudinal axis of the container such that the respective elongate member diverges away from the longitudinal axis of the container as it extends from the position of connection to the collar to the position of interaction with the respective lever.

13. A fluid dispensing device as claimed in claim 12 in which, when the or each lever is moved to cause the container to be moved towards the nozzle, the included angle between the longitudinal axis of each elongate member and the longitudinal axis of the container is reduced.

14. A fluid dispensing device as claimed in claim 5 in which, when each lever is moved to cause the container to be moved towards the nozzle, each elongate member associated therewith is subjected to elastic bending.

15. A fluid dispensing device as in claim 1 in which the actuating means is at least one resilient flexible member connected to an upper end of each lever so as to hold the or each resilient flexible member in an upwardly bowed state.

16. A fluid dispensing device as claimed in claim 15 in which the or each resilient flexible member is a leaf spring.

17. A fluid dispensing device as claimed in claim 15 in which the lower end of the or each lever is pivotally connected to the housing.

18. A fluid dispensing device of claim 15 in which the or each resilient flexible member is connected to the neck of the container by abutment of an upper surface of the or each resilient flexible member against a collar attached to the neck of the container.

19. A fluid dispensing device of claim 15 in which a stop means is provided to limit rotational movement of each lever away from the container so as to maintain the or each resilient flexible member in a bowed state.

20. A fluid dispensing device of claim 15 in which there is one lever pivotally supported at a lower end within the housing and the or each resilient flexible member is connected at one end to the upper end of the lever and is connected at an opposite end to part of the body structure of the fluid dispensing device.

21. A fluid dispensing device as claimed in claim 20 in which the part of the body structure is the housing.

22. A fluid dispensing device of claim 15 in which a stop means is provided to limit rotational movement of each lever away from the container so as to maintain the or each resilient flexible member in a bowed state, and in which there is one lever pivotally supported at a lower end within the housing and the or each resilient flexible member is connected at one end to the upper end of the lever and is connected at an opposite end to part of the body structure of the fluid dispensing device, or in which the part of the body structure is the housing, and in which the stop is positioned such that when the lever is displaced fully from the container so as to rest against the stop the linear distance between the upper end of the lever and the position of connection of the or each resilient flexible member to the part of the body structure is less than the un-bowed length of the or each resilient flexible member.

23. A fluid dispensing device of claim 20 in which the fluid dispensing device further includes an end cap to protect the nozzle and the upper end of the lever is adapted to automatically open the end cap when the lever is moved to cause the container to be moved towards the nozzle.

24. A fluid dispensing device as claimed in claim 23 in which the upper end is adapted by means of a toothed portion formed on the upper end of the lever for engagement with a complementary toothed portion on the end cap.

25. A fluid dispensing of claim 15 in which there are two levers each of which is pivotally supported at a lower end within the housing and the or each resilient flexible member is connected at one end to the upper end of one of the two levers and is connected at an opposite end to the upper end of the other of the two levers.

26. A fluid dispensing device as claimed in claim 25 in which the or each resilient flexible member and the two levers are formed as a single integral part.

27. A fluid dispensing device as claimed in claim 15, in which a stop means is provided to limit rotational movement of each lever away from the container so as to maintain the or each resilient flexible member in a bowed state, and
in which there are two levers each of which is pivotally supported at a lower end within the housing and the or each resilient flexible member is connected at one end to the upper end of one of the two levers and is connected at an opposite end to the upper end of the other of the two levers, or
in which the or each resilient flexible member and the two levers are formed as a single integral part
and in which each stop is positioned such that when the two levers are displaced fully from the container, so as to rest against their respective stops, the linear distance between the upper ends of the two levers is less than the un-bowed length of the or each resilient flexible member.

28. A fluid dispensing device as claimed in claim 2 in which the fluid discharge device has a longitudinal axis and the actuating means comprises of at least one abutment surface formed on the collar against which at least one actuating surface formed at an upper end of the or each lever is arranged to react wherein at least one of the or each actuating surface and the or each abutment surface is arranged at an angle to the longitudinal axis of the fluid discharge device so as to convert a force applied to the or each lever substantially transversely to the longitudinal axis of the fluid discharge device into a force along the longitudinal axis of the fluid discharge device.

29. A fluid dispensing device as claimed in claim 28 in which a pre-load means is provided to prevent actuation of the compression pump until a pre-determined force is applied to the or each lever.

30. A fluid dispensing device as claimed in claim 28 in which the or each abutment surface is arranged at an angle to the longitudinal axis of the fluid discharge device.

31. A fluid dispensing device as claimed in claim 30 in which the or each actuating surface is arranged at an angle to the longitudinal axis of the fluid discharge device.

32. A fluid dispensing device as claimed in claim 30 in which the or each actuating surface is a curved surface.

33. A fluid dispensing device as claimed in claim 28 in which there are plural abutment surfaces formed on the collar each being located for co-operation with a respective one of two actuating surfaces formed on the or each lever.

34. A fluid dispensing device as claimed in claim 33 in which each lever is U-shaped in cross-section having first and second flanges joined together by a bridging portion.

35. A fluid dispensing device as claimed in claim 33 in which the first flange has an end portion forming a first actuating surface and the second flange has an end portion forming a second actuating surface.

36. A fluid dispensing device as claimed in claim 28 in which each lever is pivotally supported at a lower end within the housing by a pivotal connection between the lower end of the respective lever and part of the body structure.

37. A fluid dispensing device as claimed in claim 36 in which the part of the body structure is the housing.

38. A fluid dispensing device as claimed in claim 28 in which each lever is pivotally supported at a lower end within the housing by a flexible strap joining the lower ends of the two levers.

39. A fluid dispensing device as claimed in claim 28 in which the housing has a front wall, a rear wall and two opposing side walls and at least one of the front wall and the rear wall has an aperture therein to view the level of the fluid in the container.

40. A fluid dispensing device as claimed in claim 28 in which the body structure comprises of a plastic housing and a plastic body member.

41. A fluid dispensing device as claimed in claim 39 in which the nozzle is formed as an integral part of the plastic body member.

42. A fluid dispensing device as claimed in claim 40 in which the plastic body member is fastened to the housing so that the nozzle projects from the upper end of the housing.

43. A fluid dispensing device as claimed in claim 28 in which the housing has two apertures formed therein from each of which, in use, a part of a respective one of the levers projects.

44. A fluid dispensing device as claimed in claim 28 in which the body has two apertures formed therein from each of which, in use, a part of a respective one of the levers projects.

45. A fluid dispensing device as claimed in claim 1 wherein the container contains a volume of fluid medicament formulation.

46. A fluid dispensing device as claimed in claim 45 wherein said fluid medicament formulation is in the form of a solution formulation.

47. A fluid dispensing device as claimed in claim 45 wherein said fluid medicament formulation is in the form of a suspension formulation.

48. A fluid dispensing device as claimed in claim 45 wherein the fluid medicament formulation comprises an anti-inflammatory medicament compound.

49. A fluid dispensing device as claimed in claim 48 wherein said medicament compound is a glucocorticoid compound.

50. A fluid dispensing device as claimed in claim 49 wherein said glucocorticoid compound is selected from the group consisting of 6α,9α-Difluoro-17α-(1-oxopropoxy)-11β-hydroxy-16α-methyl-3-oxo-androsta-1,4-diene-17β-carbothioic acid S-fluoromethyl ester; 6α,9α-difluoro-17α-[(2-furanylcarbonyl)oxy]-11β-hydroxy-16α-methyl-3-oxo-androsta-1,4-diene-17β-carbothioic acid S-fluoromethyl ester; and 6α,9α-Difluoro-11β-hydroxy-16α-methyl-17α-[(4-methyl-1,3-thiazole-5-carbonyl)oxy]-3-oxo-androsta-1,4-diene-17β-carbothioic acid S-fluoromethyl ester.

51. A fluid dispensing device as claimed in claim 48 wherein said medicament compound is selected from the group consisting of PDE4 inhibitors, leukotriene antagonists, iNOS inhibitors, tryptase and elastase inhibitors, beta-2 integrin antagonists and adenosine 2a agonists.

52. (canceled)

53. A housing assembly for a fluid dispensing device as claimed in claim 1 comprising
a housing for moveably supporting a discharge device,
a nozzle extending from an upper end of the housing for insertion into a body cavity and
at least one lever to apply, in use, a force to the fluid discharging device so as to actuate the fluid discharge device and supply fluid to the nozzle wherein the or each lever is pivotally supported at a lower end within the housing.

54. An assembly as claimed in claim 53 in which the or each lever is pivotally supported at a lower end within the housing by a pivotal connection between the lower end of the respective lever and the housing.

55. An assembly as claimed in claim 53 having two levers in which each lever is pivotally supported at a lower end within the housing by a flexible strap joining the lower ends of said two levers.

56-58. (canceled)
